(19) United States
(12) Patent Application Publication
(10) Pub. No.: US 2015/0302060 A1
(43) Pub. Date: Oct. 22, 2015

(54) METHOD OF IDENTIFICATION

(71) Applicant: MORPHO, Issy Les Moulineaux (FR)

(72) Inventors: Cedric THUILLIER, Issy Les Moulineaux (FR); Jerome BAYON DE NOYER, Issy Les Moulineaux (FR)

(73) Assignee: MORPHO, Issy Les Moulineaux (FR)

(21) Appl. No.: 14/437,803

(22) PCT Filed: Nov. 12, 2013
(86) PCT No.: PCT/EP2013/073655

§ 371 Date: Apr. 22, 2015

(30) Foreign Application Priority Data
Nov. 12, 2012 (FR) 12 60753

(51) Int. Cl. G06F 17/30

(52) U.S. Cl. CPC G06F 17/30528; G06F 17/30241

(57) ABSTRACT

The invention relates to a method of identifying a subject person 5 by comparing at least biometric data of the subject person with biometric data 14, 15, 16 of reference people previously recorded in a database 3. According to the invention, the comparison of the biometric data of the subject person 5 with the data of each reference person is performed by means of a first algorithm or of a second algorithm presenting different performance ratings, and, for each reference person, the comparison algorithm is selected on the basis of at least one selection criterion specific to each reference person.

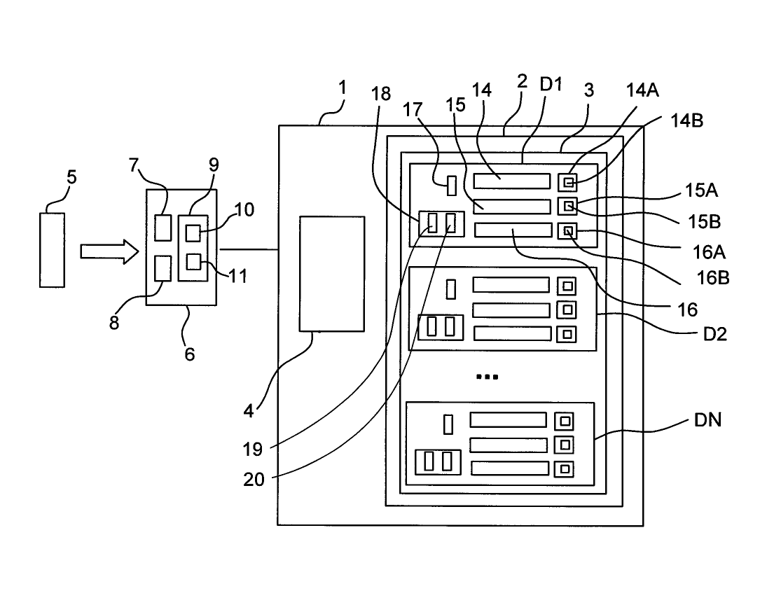

### METHOD OF IDENTIFICATION¹

The invention relates to an automatic method of identifying a subject person by performing at least one comparison between biometric data of the subject person and biometric data of reference people as previously recorded in a database. ¹Translation of the title as established ex officio.

### BACKGROUND OF THE INVENTION

Biometric identification consists in identifying a person on the basis of certain physical or behavioral characteristics of that person. Among the technologies commonly in use for recognizing physical characteristics, there are systems based on recognizing DNA, faces, the iris or the retina of an eye, palmprints, fingerprints, etc. The technologies generally used for recognizing behavioral characteristics comprise systems based on analyzing voice, writing, gait, etc.

In order to identify one subject person from a set of reference people stored in a database of a computer system, measurements are made initially for obtaining biometric data defining the physical or behavioral characteristics of the subject person. Thereafter, an algorithm performed by the processor unit of the computer system compares this biometric data with equivalent biometric data of reference people taken from the database. The subject person is then identified, naturally providing that person has already been referenced in the database.

It is naturally preferable for identification to take place as quickly as possible, i.e. by making the best use of the hardware and software resources that enable a search to be made for the subject person in the database, while nevertheless providing results that are reliable. The reliability of the results of a biometric identification method is evaluated by measuring indicators such as the rate of false positives, indicating the probability that a subject person not referenced is identified as being one of the people who have references, or the rate of false negatives, giving the probability that an already referenced person is not identified when attempting to identify a subject person.

In order to improve the reliability of identification, it is recommended to perform identification by making comparisons between several different types of biometric data. This therefore leads to performing a plurality of algorithms, either simultaneously or sequentially, which, for equivalent hardware and software resources, significantly lengthens the time needed for identification.

Document EP-A2-1 965 331 thus describes using two algorithms in succession.

### OBJECT OF THE INVENTION

An object of the invention is to provide a method of identification that makes it possible to perform identification reliably while optimizing the time needed for that identification.

### SUMMARY OF THE INVENTION

In order to achieve this object, the invention provides a method of identifying a subject person by comparing at least biometric data of the subject person with biometric data of reference people previously recorded in a database. According to the invention, the comparison of the biometric data of the subject person with the data of each reference person is performed by means of a first algorithm or of a second algorithm presenting different performance ratings, and for, each reference person, the comparison algorithm is selected on the basis of at least one selection criterion specific to each reference person.

By way of example, the method of the invention thus makes it possible to execute a very reliable comparison algorithm that is relatively slow, or else an algorithm that is faster but less reliable. Which comparison algorithm may be selected on a criterion relating to the quality of the biometric data for each reference person, thus making it possible to accelerate identification by applying a fast algorithm for comparing biometric data of one type, when the comparison of biometric data of some other type has the reputation of providing results that are satisfactory. It is also possible to select the comparison algorithm on the basis of other criteria, and in particular criteria that do not relate to the biometric data of the reference people, for the purpose of minimizing the time taken for identification whenever possible, or for the purpose of guaranteeing that identification is very reliable whenever that is necessary.

The invention can be better understood in the light of the following description of a particular, non-limiting implementation of the invention.

### BRIEF DESCRIPTION OF THE DRAWING

Reference is made to the accompanying figure, which is a diagram showing the way in which the method of the invention is performed in a particular implementation.

### DETAILED DESCRIPTION OF THE INVENTION

The method of the invention in this implementation is performed in a biometric identification application having the purpose of recognizing a subject when checking identity from among a reference population of a relatively large number of people referenced in a database.

Such an identity check may take place, for example, at the entrance to a perimeter receiving a large public event, at the entrance to a polling station, to an official building, or in the context of a police inquiry, etc.

For a subject being checked, recognition of the subject is based in this example on making a comparison between biometric data of that subject and of the reference people, which biometric data relates to two different physical characteristics: the fingerprint of a finger and the iris of an eye.

Biometric data of reference people in the database is enrolled prior to checking identities, i.e. the data is obtained by measuring the reference people in association with individual identifiers enabling each reference person to be identified and registered in the database.

With reference to the figure, checking identity requires an identification member 1, namely a computer system, that has storage means 2 in which the database 3 is stored, and processing and checking means 4 for managing the database 3 and for making comparisons between the biometric data of the subject 5 being checked, and each of the reference people.

The identification member 1 is connected to acquisition means 6 that serve to obtain the biometric data of the subject concerning the fingerprint and the iris of the eye. The acquisition means 6 include means 7 for capturing an image of the fingerprint, e.g. a capacitive technology sensor for detecting skin patterns, and means 8 for capturing an image of the iris, e.g. a charge-coupled device (CCD) type camera, together with formatting means 9 that comprise in particular means 10 for performing analog-to-digital conversion and digital processor means 11. The analog-to-digital converter means 10 are arranged to transform the analog data supplied by the capture means 7 and 8 into digital signals. The digital processor means 11 are arranged to convert these digital signals into biometric data of the subject 5 being checked relating to the fingerprint and the iris, and in a form suitable for being compared with the biometric data of the reference people.

The database stores reference data D1, D2, . . . , DN for some number N of reference people. For each reference person, the reference data contains:
biometric data 14 relating to at least one fingerprint;
biometric data 15 relating to the iris of at least one eye;
biometric data 16 of some other type, i.e. relating to some other physical or behavioral characteristic, that is not used in the present example but that could be used in some other application;
optimization data 14A, 15A, 16A associated with each type of biometric data, for a purpose that is explained below;
identity data 17 for identifying the reference person; and
independent data 18 specific to a reference person for a purpose that is also explained below.

When checking identity, the checking means 4 compare the biometric data of the subject 5 being checked with the biometric data of each of the reference people. The checking means 4 then identify the reference person, if one exists, that has the physical characteristics in question that are the closest to those of the subject 5 being checked.

The method of the invention makes provision, for each identity check, to perform recognition twice, based on the two physical characteristics (fingerprint and iris). Such double recognition serves to increase the reliability of the checking. For each of these physical characteristics, at least two algorithms are implemented in the checking means 4 for the purpose of comparing the subject 5 being checked with each of the reference people: these algorithms comprise a first algorithm and a second algorithm that takes longer to execute than the first algorithm, but that provides results that are more reliable. In this context, the term “more reliable” should be understood to mean that the rates of errors of the false positive type or of the false negative type are smaller.

The method of the invention makes provision for selecting the first algorithm or the second algorithm so as to optimize the speed at which identities are checked and so as to optimize the reliability of the checking.

This selection between the first and second algorithms is performed on the basis of one criterion out of three criteria, or indeed on the basis of several criteria taken into account simultaneously, which criteria are made available to the user in charge of checking identities, or else they are previously defined, e.g. by programming, in the identification member 1.

The first criterion associated with each reference person is a quality level 14B, 15B, 15B for the biometric data 14, 15, 16 relating to any one characteristic, thereby making it possible to evaluate the uniqueness of the reference person concerning this characteristic relative to the remainder of the database 3. This quality level may consist in a value in the range zero to one hundred. Thus, a particularly rare fingerprint pattern will give a reference person a high value close to one hundred. This quality level 14B, 15B, 16B associated with the biometric data 14, 15, 16 of each characteristic for each reference person is stored in the optimization data 14A, 15A, 16A.

When such a criterion is used, the method of the invention selects a comparison algorithm for comparing the biometric data relating to the fingerprint by comparing a predefined threshold for the quality level value 15B associated with the biometric data 15 relating to the iris. For example, if the threshold is equal to fifty, and if the numerical score for the iris of a particular reference individual is equal to seventy, that means that the quality level of the iris data is relatively high, so the faster but less reliable first algorithm is selected. It is probable that if the particular reference person and the subject 5 are the same person, then the subject 5 can be identified using the iris. Conversely, if the value associated with the iris of the particular reference person is low, then the slower but more reliable second algorithm should be selected.

Advantageously, provision is made for the checking means 4 to be capable of changing dynamically the predetermined threshold and/or the quality level value specific to a reference person for any particular characteristic. For example, it may be advantageous to reduce the threshold value if the biometric data is considered to be of poor quality for too great a number of people. It is also possible that adding new reference people to the database 3 makes it necessary to reduce the quality level values of certain people who were referenced prior to these new people.

The second criterion is a criterion that is independent of the biometric data 14, 15, 16 and that makes it possible, for certain particular reference people presenting particularity information 19 that makes it necessary to ensure that identification is as reliable as possible, to make provision for using only the second algorithm, regardless of the quality of that person's biometric data. By way of example, this criterion can serve to distinguish between reference people who are particularly dangerous, where reliable identification is crucial and makes it acceptable for the time required for identification to be longer. The particularity information 19 is stored in the independent data 18.

The third criterion serves to evaluate the geographical distance between the locations where the biometric data 14, 15, 16 of a particular reference person was enrolled and where the data of the subject 5 was enrolled. The probability that the subject 5 and the particular reference person are the same person is considerably greater if their data is enrolled at locations that are close together. The first algorithm is then sufficient for providing reliable recognition. Information 20 about the place of enrollment is also stored in the independent data 18.

The invention is not limited to the particular implementation described above, but on the contrary covers any variant coming within the ambit of the invention as defined by the claims.

Although for the purpose of illustrating the invention the present description makes use of the reliability and the speed of execution in order to define the performance rating of an algorithm, it is naturally possible to implement the method of the invention while taking account of other properties of algorithms (use of memory resources, etc.).

Although provision is made to identify a subject on the basis of a certain number of particular physical characteristics, it is possible to use some other number of different characteristics.

Although particular characteristics are defined for selecting a comparison algorithm, it is possible to select criteria that are completely different.

By way of example, the first criterion may be associated with the number of characteristic points stored in association with a fingerprint, the quality with which an image of an iris has been captured, . . . .

1. A method of identifying a subject person by comparing at least biometric data of the subject person with biometric data of reference people previously recorded in a database, the method being characterized in that the comparison of the biometric data of the subject person with the data of each reference person is performed by means of a first algorithm or of a second algorithm presenting different performance ratings, and in that, for each reference person, the comparison algorithm is selected on the basis of at least one selection criterion specific to each reference person.

2. A method according to claim 1, wherein the selection criterion corresponds to a quality level associated with the biometric data of each reference person and one or the other algorithm is selected as a function of comparing the quality level with a predetermined threshold.

3. A method according to claim 2, wherein two biometric data comparisons are performed on biometric data of different types.

4. A method according to claim 2, wherein one or the other algorithm is selected for comparing biometric data of a certain type as a function of the comparison with a quality level threshold allocated to biometric data of another type.

5. A method according to claim 2, wherein the quality level allocated to at least one type of biometric data of one of the reference people and/or the predetermined threshold can be modified dynamically.

6. A method according to claim 1, wherein, for each reference person, the selection criterion depends on the reference person and on the subject person.

7. A method according to claim 6, wherein, for each reference person, the selection criterion depends on the geographical distance between the enrollment locations for the biometric data of the subject person and for the biometric data of the reference person.
